(19) United States
(12) Patent Application Publication
(10) Pub. No.: US 2023/0390680 A1
(43) Pub. Date: Dec. 7, 2023

(54) FILTRATION IN A VAPOR DELIVERY SYSTEM

(71) Applicant: ENTEGRIS, INC., Billerica, MA (US)

(72) Inventors: Scott L. Battle, Cedar Park, TX (US); Jacob Thomas, Leander, TX (US)

(21) Appl. No.: 18/204,099

(22) Filed: May 31, 2023

Related U.S. Application Data
(60) Provisional application No. 63/348,807, filed on Jun. 3, 2022.

(51) Int. Cl. B01D 46/00; B01D 46/42

(52) U.S. Cl. CPC B01D 46/0002; B01D 46/42; B01D 2201/302; B01D 2239/0478

(57) ABSTRACT

A filter assembly includes a fluid inlet; a fluid outlet; a conduit; and a filter. The conduit is fluidly connected to the fluid inlet and the filter. The filter is fluidly connected to the conduit and the fluid outlet. The filter assembly is configured for flowing at least one of the following fluids: MoO₂Cl₂, MoOCl₄, MoCl₅, WCl₆, WCl₅, WOCl₄, WO₂Cl₂, or any combination thereof. The filter is configured to collect a molybdenum residue, a tungsten residue, or any combination thereof from the fluid resulting in the filtered fluid.

### PRIORITY CLAIM

This disclosure claims priority to U.S. provisional patent No. 63/348,807 with a filing date of Jun. 3, 2022, which is incorporated by reference herein.

### FIELD

This disclosure relates generally to vapor delivery systems. More specifically, this disclosure relates to filtration in a vapor delivery system such as, but not limited to, a vapor delivery system configured to deliver a molybdenum vapor.

### BACKGROUND

Various materials suffer from unwanted corrosion when the materials are exposed to chemical vapors, such as molybdenum vapor. Increased heat, pressure, or both can enhance the unwanted corrosion.

### SUMMARY

In some embodiments, a filter assembly includes a fluid inlet; a fluid outlet; a conduit; and a filter. In some embodiments, the conduit is fluidly connected to the fluid inlet and the filter. In some embodiments, the filter is fluidly connected to the conduit and the fluid outlet. In some embodiments, the filter assembly is configured for flowing at least one of the following fluids: MoO₂Cl₂, MoOCl₄, MoCl₅, WCl₆, WCl₅, WOCl₄, WO₂Cl₂, or any combination thereof. In some embodiments, the filter is configured to collect a molybdenum residue, a tungsten residue, or any combination thereof from the fluid resulting in the filtered fluid.

In some embodiments, the filter assembly includes a first end and a second end opposite the first end, wherein the fluid inlet and the fluid outlet are both located at the first end.

In some embodiments, the conduit is configured for fluid flow in a first direction and the filter is configured for fluid flow in a second direction. In some embodiments, the second direction is opposite the first direction.

In some embodiments, the filter assembly includes a ballast member fluidly connected between the conduit and the filter.

In some embodiments, a system includes a manifold including a fluid inlet and a fluid outlet. In some embodiments, the fluid inlet is configured to receive a vapor. In some embodiments, the fluid outlet is configured to output the vapor. In some embodiments, a conduit is fluidly connected to the fluid inlet and configured to receive the vapor. In some embodiments, a filter is fluidly connected to the conduit at a filter inlet and configured to receive the vapor from the conduit. In some embodiments, the filter is fluidly connected to the fluid outlet at a filter outlet and configured to output a filtered vapor to the fluid outlet. In some embodiments, the filter is configured to remove at least a portion of a molybdenum residue, a tungsten residue, or any combination thereof in the vapor resulting in the filtered vapor. In some embodiments, the vapor includes at least one of MoO₂Cl₂, MoOCl₄, MoCl₅, WCl₆, WCl₅, WOCl₄, WO₂Cl₂, or any combination thereof.

In some embodiments, the system includes a ballast member. In some embodiments, the ballast member includes a ballast inlet and a ballast outlet. In some embodiments, the ballast inlet is configured to be fluidly connected to the conduit and the ballast outlet is configured to be fluidly connected to the filter. In some embodiments, the ballast member includes a housing configured to control a pressure gradient of the vapor from the conduit to the filter.

In some embodiments, the system includes a coating covering at least a portion of the filter, covering at least a portion of the conduit, or a combination thereof. In some embodiments, the coating is configured to be exposed to the vapor. In some embodiments, the coating includes at least one of a metal oxide, a metal alloy, an elemental metal, a quartz, or any combination thereof. In some embodiments, the coating includes a metal oxide.

In some embodiments, the manifold is configured to fluidly connect the fluid inlet and the conduit, fluidly connect the filter and the fluid outlet, and maintain a separation between the fluid inlet and the fluid outlet.

In some embodiments, the molybdenum residue, the tungsten residue, or any combination thereof includes solid particulate matter, wherein the filter is configured to remove the solid particulate matter from a fluid stream.

In some embodiments, the filter is configured for filtration with fluids at a temperature of 100° C. or greater.

In some embodiments, the filter is configured for filtration with fluids at a temperature of 100° C. to 250° C.

In some embodiments, the filter is configured for filtration with fluids at a pressure of up to 1 MPa.

In some embodiments, the filter is a flow through filter. In some embodiments, the filter is a filter other than a flow through filter.

In some embodiments, a vapor delivery system includes the system.

In some embodiments, a method includes obtaining a system configured to filter a vapor. In some embodiments, the system includes a member including a fluid inlet and a fluid outlet; the fluid inlet configured to receive a vapor; the fluid outlet configured to output the vapor; a conduit fluidly connected to the fluid inlet and configured to receive the vapor; and a filter fluidly connected to the conduit at a filter inlet and configured to receive the vapor from the conduit, the filter fluidly connected to the fluid outlet at a filter outlet and configured to output a filtered vapor to the fluid outlet. In some embodiments, the filter is configured to remove at least a portion of a molybdenum residue, a tungsten residue, or any combination thereof in the filtered vapor. In some embodiments, the vapor includes at least one of MoO₂Cl₂, MoOCl₄, MoCl₅, WCl₆, WCl₅, WOCl₄, WO₂Cl₂, or any combination thereof. In some embodiments, the method includes installing the system to a vapor delivery system. In some embodiments, the system is installed into a delivery manifold of the vapor delivery system.

In some embodiments, the method includes obtaining a ballast member; and installing the ballast member between the conduit and the filter.

In some embodiments, installing the system to a vapor delivery system includes retrofitting the system to a vapor delivery system having been previously operated.

### BRIEF DESCRIPTION OF THE DRAWINGS

References are made to the accompanying drawings that form a part of this disclosure and that illustrate embodiments in which the systems and methods described in this Specification can be practiced.

FIG. 1 shows a filter assembly, according to some embodiments.

FIG. 2 shows a sectional view of the filter assembly of FIG. 1, according to some embodiments.

FIG. 3 shows a flowchart of a method, according to some embodiments.

FIG. 4 shows a sectional view of a filter assembly, according to some embodiments.

FIG. 5 shows a sectional view of a filter assembly, according to some embodiments.

FIG. 6 shows a sectional view of a filter assembly, according to some embodiments.

Like reference numbers represent the same or similar parts throughout.

### DETAILED DESCRIPTION

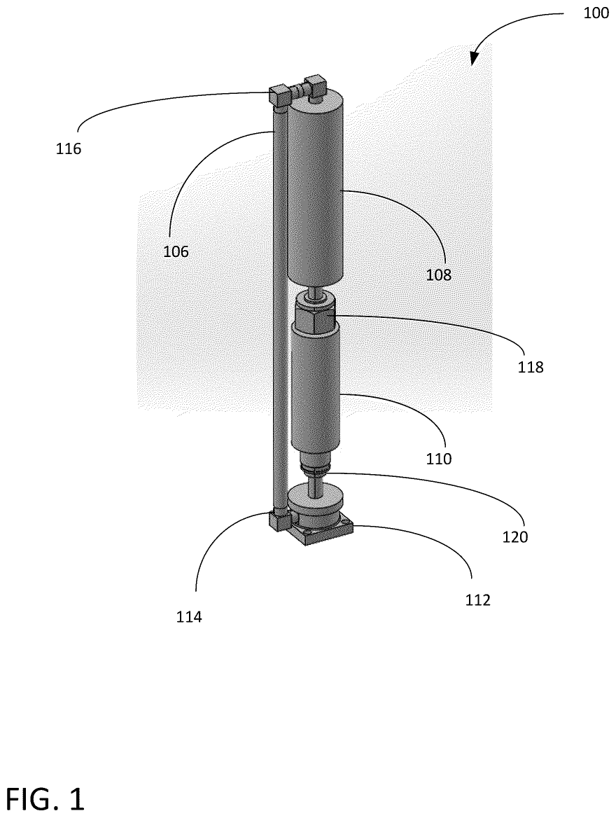

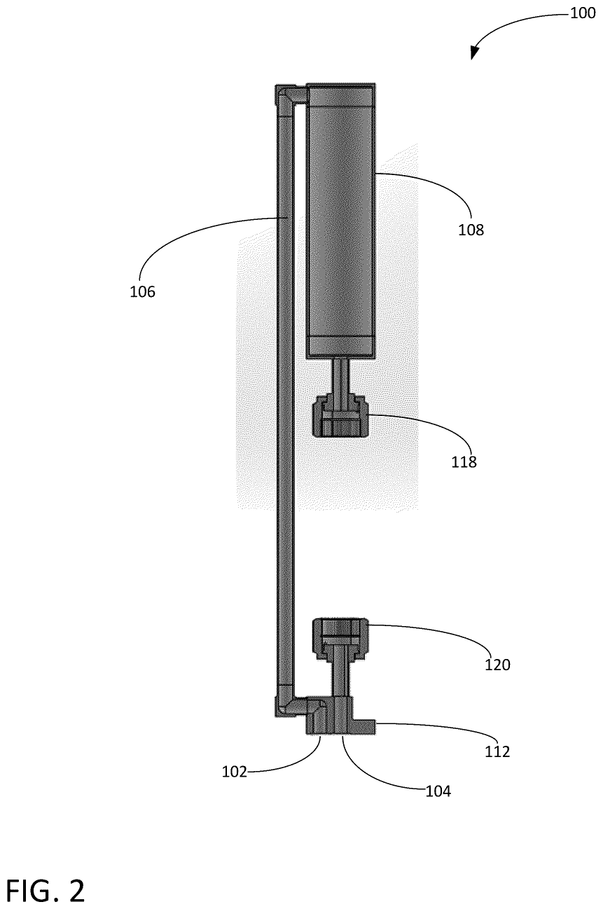

FIG. 1 shows a filter assembly 100, according to some embodiments. FIG. 2 shows a sectional view of the filter assembly 100 of FIG. 1, according to some embodiments. FIGS. 1 and 2 will be described collectively unless specific reference is made otherwise.

The filter assembly 100 is configured for use in a vapor delivery system. For example, in some embodiments, the filter assembly 100 can be used in a vapor delivery system configured to deliver at least one of the following fluids: MoO₂Cl₂, MoOCl₄, MoCl₅, WCl₆, WCl₅, WOCl₄, WO₂Cl₂, or any combination thereof. In some embodiments, the filter assembly 100 can be disposed in a hot fluid chamber of the vapor delivery system. In some embodiments, the hot fluid chamber of the vapor delivery system may be disposed upstream of an output valve at which the fluid is delivered from the vapor delivery system for its utilization.

In the illustrated embodiment, the filter assembly 100 includes a fluid inlet 102, a fluid outlet 104, a conduit 106, a ballast member 108, and a filter 110 fluidly connected together and configured to receive an unfiltered fluid and output a filtered fluid. In some embodiments, the filter assembly 100 is configured to collect at least a portion of a molybdenum residue, a tungsten residue, or any combination thereof from the unfiltered fluid, resulting in the filtered fluid. In some embodiments, the molybdenum residue, tungsten residue, or any combination thereof, can include solid particulate matter. In some embodiments, the filter 110 can remove the solid particulate matter from the fluid stream. In some embodiments, the filter 110 can remove solid particulate matter from the fluid stream other than molybdenum residue, tungsten residue, or combinations thereof.

The fluid inlet 102 and the fluid outlet 104 can be disposed in a manifold 112. The manifold 112 can receive a fluid (e.g., the vapor being delivered) and divert the fluid through the conduit 106, the ballast member 108, and the filter 110. In some embodiments, the fluid flow is configured to be in a first direction into the fluid inlet 102 and in a second direction out from the fluid outlet 104. In some embodiments, the first direction is opposite the second direction. In some embodiments, the manifold 112 is sealed between the fluid inlet 102 and the fluid outlet 104 so that the unfiltered fluid is not able to bypass the filter 110.

The conduit 106 is configured to have an inlet end 114 and an outlet end 116. The inlet end 114 is configured to receive the fluid from the manifold 112. The outlet end 116 is configured to output the fluid to the ballast member 108.

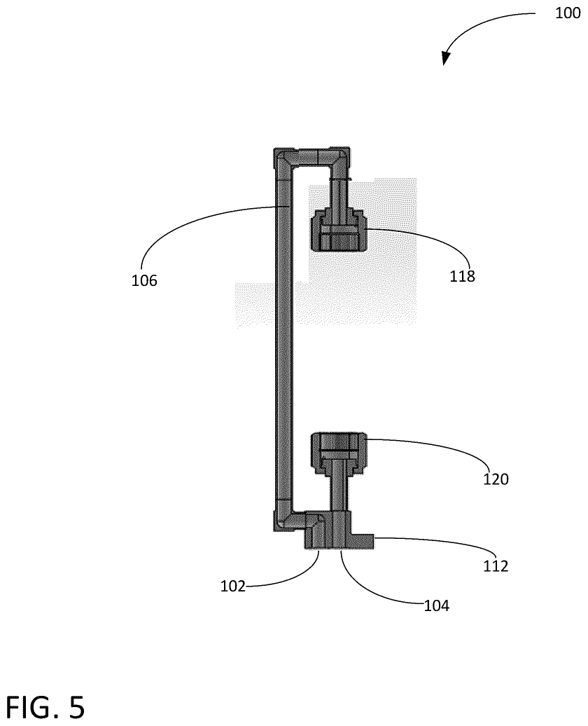

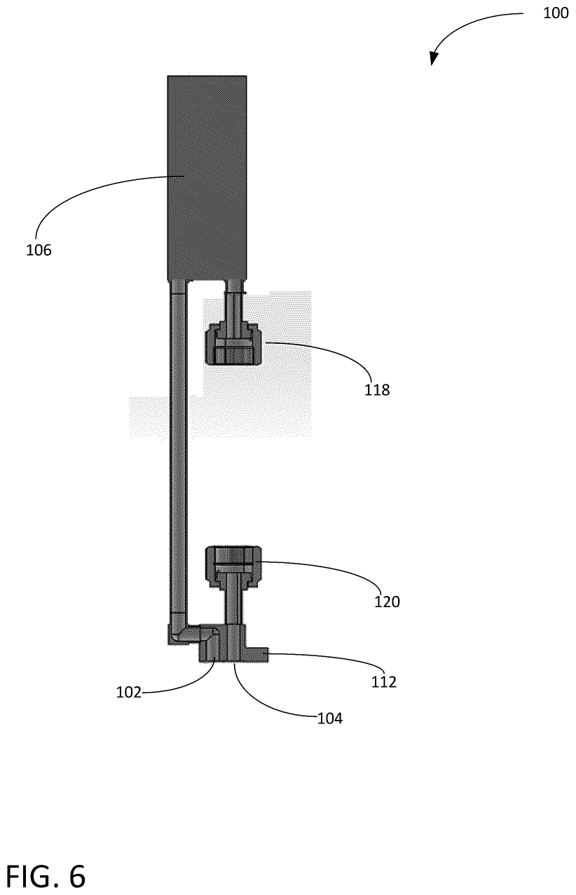

The ballast member 108 is configured to manage pressure gradients of the fluid prior to the fluid being flowed through the filter 110. In some embodiments, the ballast member 108 can be optional. In such embodiments, the filter 110 can have a longer length than shown in the illustrated embodiment to take the place of the ballast member 108 that is not included. In some embodiments, the ballast member 108 may not be included. Such an embodiment is illustrated in FIG. 5. In some embodiments, the ballast member 108 can be replaced by a conduit having multiple diameters. Such an embodiment is illustrated in FIG. 6.

In some embodiments, the filter 110 is an in-line filter. In some embodiments, a length L1 of the filter 110 can be maximized to optimize filtration. In some embodiments, an overall length of the filter 110 and the ballast member 108 can be limited due to the placement of the filter assembly 100 within the vapor delivery system. It is to be appreciated that an in-line filter is an example filter for the filter 110 and that the filter 110 can include other types of filters besides in-line filters. In some embodiments, an efficacy of the filter 110 can be measured based on a number of particles deposited on a wafer from use of the filtered vapor. In some embodiments, the filter 110 is configured to provide a resulting filtered vapor having less than less than 100 particles per wafer; less than 10 particles per wafer; less than 1 particle per wafer; 1 particle per wafer to 10 particles per wafer; 1 particle per wafer to 100 particles per wafer; or 1 particle per wafer to 1,000 particles per wafer. In some embodiments, the filter 110 is configured to provide a resulting filtered vapor having less than 1 particle per 10 wafers at an average particle size of 1 nm to 100 nm, such as, for example and without limitation, an average particle size of 10 nm to 30 nm (e.g., 20 nm).

In some embodiments, the filter 110 is configured for filtration in a high temperature application. In some embodiments, high temperature applications can include temperatures up to 250° C. In some embodiments, high temperature applications can include temperatures of 100° C. to 250° C.; 110° C. to 250° C.; 120° C. to 250° C.; 130° C. to 250° C.; 140° C. to 250° C.; 150° C. to 250° C.; 160° C. to 250° C.; 170° C. to 250° C.; 180° C. to 250° C.; 190° C. to 250° C.; 200° C. to 250° C.; 210° C. to 250° C.; 220° C. to 250° C.; 230° C. to 250° C.; or 240° C. to 250° C. In some embodiments, the filter 110 can also be utilized at operating temperatures of 0° C. to 120° C. In some embodiments, the filter 110 can utilize a fluoropolymer membrane such as, but not limited to, a polytetrafluoroethylene (PTFE) membrane or the like. In some embodiments, a support for the membrane can utilize a fluoropolymer such as, but not limited to, perfluoroalkoxy alkanes (PFA) or the like. In some embodiments, the filter 110 can include a housing formed of stainless steel or the like.

In some embodiments, the filter 110 is configured for filtration applications with fluids at a pressure of up to 1 MPa; up to 0.9 MPa; up to 0.8 MPa; up to 0.7 MPa; up to 0.6 MPa; up to 0.5 MPa; up to 0.4 MPa; up to 0.3 MPa; up to 0.2 MPa; up to 0.1 MPa; 1 Pa to 1 MPa; 10 Pa to 1 MPa; 100 Pa to 1 MPa; 1000 Pa to 1 MPa; 0.01 MPa to 1 MPa; 0.1 MPa to 1 MPa; 0.2 to 1 MPa; 0.3 to 1 MPa; 0.4 to 1 MPa; 0.5 to 1 MPa; 0.6 to 1 MPa; 0.7 to 1 MPa; 0.8 to 1 MPa; or 0.9 to 1 MPa.

In some embodiments, an outlet pressure of the fluid from the vapor delivery system can be important. Accordingly, in some embodiments, the filter 110 can be selected to minimize a pressure drop in the fluid.

In some embodiments, the filter 110 can be replaceable. That is, in some embodiments, a connection 118 and a connection 120 can be used to secure the filter 110 within the filter 110. In some embodiments, the connection 118 and the connection 120 include a vacuum coupling radiation (VCR) connection. In some embodiments, the filter 110 can have corresponding connections on each end to install within the filter assembly 100. For example, in some embodiments, the filter assembly 100 can include threaded nuts configured to be tightened onto threaded posts of the filter 110.

In some embodiments, one or more of the components of the filter assembly 100 are configured to be exposed to chemical vapor(s), such as MoO₂Cl₂, MoOCl₄, MoCl₅, WCl₆, WCl₅, WOCl₄, WO₂Cl₂, or any combination thereof. In some embodiments, a surface of the components of the filter assembly 100 that is to be exposed to the chemical vapor(s) is protected by a surface treatment, an added coating, or a combination thereof. While such coating can be understood to reduce or inhibit mass loss due to corrosion, it has been surprising to determine that certain types of surface treatment, added coating, or both can also beneficially reduce the mass gain at the surface. Further, certain types of surface treatment, added coating, or both can also reduce and/or inhibit the residue formation on the surface as well.

According to some embodiments, the coating can include at least one of a metal oxide, a metal alloy, an elemental metal, a quartz, or any combination thereof. In some embodiments, the coating comprises a metal oxide, and the metal oxide can be at least one of an aluminum oxide, a silicon oxide, an yttrium oxide, a magnesium oxide, a calcium oxide, a zirconium oxide, a hafnium oxide, a boron oxide, or any combination thereof. In some embodiments, the coating comprises a metal alloy, such as an alloy including molybdenum (Mo). In some exemplary embodiments, the coating includes at least one of aluminum (Al), silicon (Si), yttrium (Y), magnesium (Mg), calcium (Ca), zirconium (Zr), hafnium (Hf), boron (B), or any combination thereof. In some exemplary embodiments, the coating includes at least one of yttria, alumina, silica, graphite, sputtered nickel, fluorinated metal alloy, polished stainless steel, borosilicate glass, or any combination thereof.

Accordingly, in various embodiments of devices and methods include a coating on devices configured to be exposed to chemical vapors (such as WCl₅ and/or MoO₂Cl₂). In some embodiments, the coating reduces or inhibits the mass change (mass gain or mass loss) in per unit area of equal to or less than 1×10⁻⁵ g mm⁻².

In some embodiments, the filter assembly 100 can be installed into a vapor delivery system during manufacturing of the vapor delivery system. In some embodiments, the filter assembly 100 can be installed into a vapor delivery system after the vapor delivery system has been in use. That is, in some embodiments, the filter assembly 100 can be retrofit into a vapor delivery system that has previously been operated.

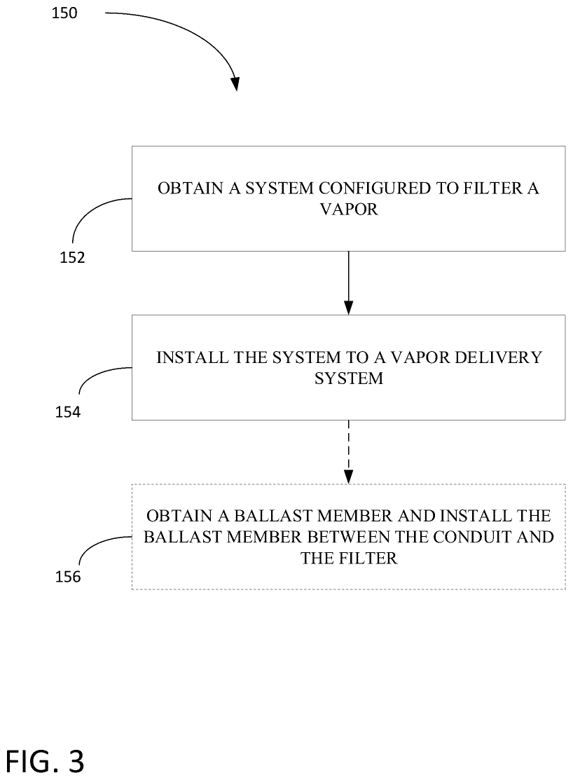

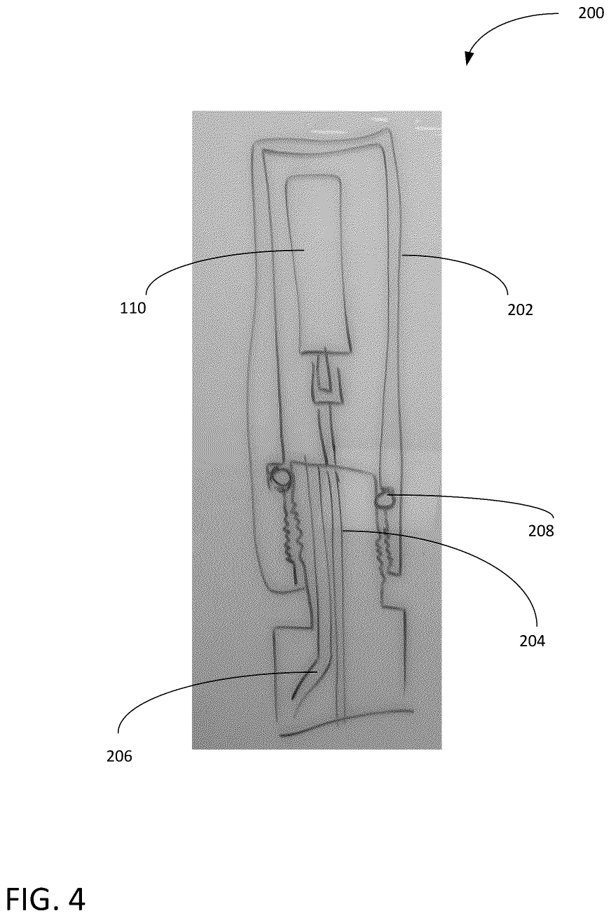

FIG. 3 shows a flowchart of a method 150, according to some embodiments. The method 150 can be used to install a filter assembly (e.g., the filter assembly 100 of FIGS. 1-2) into a vapor delivery system. In some embodiments, the method 150 can be used to install other embodiments of filter assemblies (e.g., FIGS. 4-6 below) into a vapor delivery system.

At block 152, the method 150 includes obtaining a system configured to filter a vapor. In some embodiments, the system includes a member comprising a fluid inlet and a fluid outlet. In some embodiments, the fluid inlet is configured to receive a vapor. In some embodiments, the fluid outlet is configured to output the vapor. In some embodiments, a conduit is fluidly connected to the fluid inlet and configured to receive the vapor. In some embodiments, a filter fluidly is connected to the conduit at a filter inlet and configured to receive the vapor from the conduit. In some embodiments, the filter is fluidly connected to the fluid outlet at a filter outlet and configured to output a filtered vapor to the fluid outlet. In some embodiments, the filter is configured to remove at least a portion of a molybdenum residue, a tungsten residue, or any combination thereof in the filtered vapor. In some embodiments, the vapor includes at least one of MoO₂Cl₂, MoOCl₄, MoCl₅, WCl₆, WCl₅, WOCl₄, WO₂Cl₂, or any combination thereof.

At block 154, the method 150 includes installing the system to a vapor delivery system. In some embodiments, the installing the system to a vapor delivery system including retrofitting the system to a vapor delivery system having been previously operated.

In some embodiments, optionally at block 156, the method 150 includes obtaining a ballast member and installing the ballast member between the conduit and the filter.

FIG. 4 shows a sectional view of a filter assembly 200, according to some embodiments. For simplicity of this Specification, aspects of features already described will not be described in additional detail unless specifically noted otherwise.

In the illustrated embodiment, the filter assembly 200 includes a housing 202. The housing 202 includes an inlet 204 and an outlet 206. The inlet 204 is fluidly connected to a filter 110. An unfiltered fluid can be received at the inlet 204 and provided to the filter 110. The filtered fluid can be output from the outlet 206. The filter assembly 200 also includes a seal 208 configured to seal the housing 202 so that the filtered fluid can be output from the outlet 206 without leaking out of the housing 202.

It is to be appreciated that any of aspects 1-5 can be combined with any of aspects 6-18, 19, or 20-22. Any of aspects 6-18 can be combined with any of aspects 19 or 20-22. Aspect 19 can be combined with any of aspects 20-22.

Aspect 1. A filter assembly, comprising: a fluid inlet; a fluid outlet; a conduit; and a filter, wherein the conduit is fluidly connected to the fluid inlet and the filter, wherein the filter is fluidly connected to the conduit and the fluid outlet, wherein the filter assembly is configured for flowing at least one of the following fluids: MoO₂Cl₂, MoOCl₄, MoCl₅, WCl₆, WCl₅, WOCl₄, WO₂Cl₂, or any combination thereof; wherein the filter is configured to collect a molybdenum residue, a tungsten residue, or any combination thereof from the fluid resulting in the filtered fluid.

Aspect 2. The filter assembly of aspect 1, comprising a first end and a second end opposite the first end, wherein the fluid inlet and the fluid outlet are both located at the first end.

Aspect 3. The filter assembly of aspect 1 or 2, wherein the conduit is configured for fluid flow in a first direction, wherein the filter is configured for fluid flow in a second direction.

Aspect 4. The filter assembly of aspect 3, wherein the second direction is opposite the first direction.

Aspect 5. The filter assembly of any one of aspects 1-4, further comprising a ballast member fluidly connected between the conduit and the filter.

Aspect 6. A system, comprising: a manifold comprising a fluid inlet and a fluid outlet; wherein the fluid inlet configured to receive a vapor; wherein the fluid outlet configured to output the vapor; a conduit fluidly connected to the fluid inlet and configured to receive the vapor; and a filter fluidly connected to the conduit at a filter inlet and configured to receive the vapor from the conduit, the filter fluidly connected to the fluid outlet at a filter outlet and configured to output a filtered vapor to the fluid outlet; wherein the filter is configured to remove at least a portion of a molybdenum residue, a tungsten residue, or any combination thereof in the vapor resulting in the filtered vapor; wherein the vapor comprises at least one of MoO₂Cl₂, MoOCl₄, MoCl₅, WCl₆, WCl₅, WOCl₄, WO₂Cl₂, or any combination thereof.

Aspect 7. The system of aspect 6, further comprising a ballast member.

Aspect 8. The system of aspect 7, wherein the ballast member includes a ballast inlet and a ballast outlet, wherein the ballast inlet is configured to be fluidly connected to the conduit and the ballast outlet is configured to be fluidly connected to the filter, wherein the ballast member comprises a housing configured to control a pressure gradient of the vapor from the conduit to the filter.

Aspect 9. The system of any one of aspects 6-8, comprising a coating covering at least a portion of the filter, covering at least a portion of the conduit, or a combination thereof.

Aspect 10. The system of aspect 9, wherein the coating is configured to be exposed to the vapor.

Aspect 11. The system of aspect 10, wherein the coating comprises at least one of a metal oxide, a metal alloy, an elemental metal, a quartz, or any combination thereof.

Aspect 12. The system of aspect 10, wherein the coating comprises a metal oxide.

Aspect 13. The system of any one of aspects 6-12, wherein the manifold is configured to fluidly connect the fluid inlet and the conduit, fluidly connect the filter and the fluid outlet, and maintain a separation between the fluid inlet and the fluid outlet.

Aspect 14. The system of aspect 13, wherein the molybdenum residue, the tungsten residue, or any combination thereof comprises solid particulate matter, wherein the filter is configured to remove the solid particulate matter from a fluid stream.

Aspect 15. The system of any one of aspects 6-14, wherein the filter is configured for filtration with fluids at a temperature of 100° C. or greater.

Aspect 16. The system of aspect 15, wherein the filter is configured for filtration with fluids at a temperature of 100° C. to 250° C.

Aspect 17. The system of any one of aspects 6-16, wherein the filter is configured for filtration with fluids at a pressure of up to 1 MPa.

Aspect 18. The system of any one of aspects 6-17, wherein the filter is a flow through filter.

Aspect 19. A vapor delivery system, comprising the system of any one of aspects 6-18.

Aspect 20. A method, comprising: obtaining a system configured to filter a vapor, wherein the system comprises: a member comprising a fluid inlet and a fluid outlet; wherein the fluid inlet configured to receive a vapor; wherein the fluid outlet configured to output the vapor; a conduit fluidly connected to the fluid inlet and configured to receive the vapor; and a filter fluidly connected to the conduit at a filter inlet and configured to receive the vapor from the conduit, the filter fluidly connected to the fluid outlet at a filter outlet and configured to output a filtered vapor to the fluid outlet; wherein the filter is configured to remove at least a portion of a molybdenum residue, a tungsten residue, or any combination thereof in the filtered vapor; wherein the vapor comprises at least one of MoO₂Cl₂, MoOCl₄, MoCl₅, WCl₆, WCl₅, WOCl₄, WO₂Cl₂, or any combination thereof; and installing the system to a vapor delivery system, wherein the system is installed into a delivery manifold of the vapor delivery system.

Aspect 21. The method of aspect 20, comprising obtaining a ballast member; and installing the ballast member between the conduit and the filter.

Aspect 22. The method of aspect 20 or 21, wherein the installing the system to a vapor delivery system including retrofitting the system to a vapor delivery system having been previously operated.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A filter assembly, comprising:
a fluid inlet;
a fluid outlet;
a conduit; and
a filter,
wherein the conduit is fluidly connected to the fluid inlet and the filter,
wherein the filter is fluidly connected to the conduit and the fluid outlet,
wherein the filter assembly is configured for flowing at least one of the following fluids: MoO₂Cl₂, MoOCl₄, MoCl₅, WCl₆, WCl₅, WOCl₄, WO₂Cl₂, or any combination thereof;
wherein the filter is configured to collect a molybdenum residue, a tungsten residue, or any combination thereof from the fluid resulting in the filtered fluid.

2. The filter assembly of claim 1, comprising a first end and a second end opposite the first end, wherein the fluid inlet and the fluid outlet are both located at the first end.

3. The filter assembly of claim 1, wherein the conduit is configured for fluid flow in a first direction, wherein the filter is configured for fluid flow in a second direction.

4. The filter assembly of claim 3, wherein the second direction is opposite the first direction.

5. The filter assembly of claim 1, further comprising a ballast member fluidly connected between the conduit and the filter.

6. A system, comprising:
a manifold comprising a fluid inlet and a fluid outlet;
wherein the fluid inlet configured to receive a vapor;
wherein the fluid outlet configured to output the vapor;
a conduit fluidly connected to the fluid inlet and configured to receive the vapor; and
a filter fluidly connected to the conduit at a filter inlet and configured to receive the vapor from the conduit, the filter fluidly connected to the fluid outlet at a filter outlet and configured to output a filtered vapor to the fluid outlet;
wherein the filter is configured to remove at least a portion of a molybdenum residue, a tungsten residue, or any combination thereof in the vapor resulting in the filtered vapor;
wherein the vapor comprises at least one of MoO₂Cl₂, MoOCl₄, MoCl₅, WCl₆, WCl₅, WOCl₄, WO₂Cl₂, or any combination thereof.

7. The system of claim 6, further comprising a ballast member.

8. The system of claim 7, wherein the ballast member includes a ballast inlet and a ballast outlet, wherein the ballast inlet is configured to be fluidly connected to the conduit and the ballast outlet is configured to be fluidly connected to the filter, wherein the ballast member comprises a housing configured to control a pressure gradient of the vapor from the conduit to the filter.

9. The system of claim 6, comprising a coating covering at least a portion of the filter, covering at least a portion of the conduit, or a combination thereof.

10. The system of claim 9, wherein the coating is configured to be exposed to the vapor.

11. The system of claim 10, wherein the coating comprises at least one of a metal oxide, a metal alloy, an elemental metal, a quartz, or any combination thereof.

12. The system of claim 10, wherein the coating comprises a metal oxide.

13. The system of claim 6, wherein the manifold is configured to fluidly connect the fluid inlet and the conduit, fluidly connect the filter and the fluid outlet, and maintain a separation between the fluid inlet and the fluid outlet.

14. The system of claim 13, wherein the molybdenum residue, the tungsten residue, or any combination thereof comprises solid particulate matter, wherein the filter is configured to remove the solid particulate matter from a fluid stream.

15. The system of claim 6, wherein the filter is configured for filtration with fluids at a temperature of 100° C. or greater.

16. The system of claim 15, wherein the filter is configured for filtration with fluids at a temperature of 100° C. to 250° C.

17. The system of claim 6, wherein the filter is configured for filtration with fluids at a pressure of up to 1 MPa.

18. The system of claim 6, wherein the filter is a flow through filter.

19. A method, comprising:
obtaining a system configured to filter a vapor, wherein the system comprises:
a member comprising a fluid inlet and a fluid outlet;
wherein the fluid inlet configured to receive a vapor;
wherein the fluid outlet configured to output the vapor;
a conduit fluidly connected to the fluid inlet and configured to receive the vapor; and
a filter fluidly connected to the conduit at a filter inlet and configured to receive the vapor from the conduit, the filter fluidly connected to the fluid outlet at a filter outlet and configured to output a filtered vapor to the fluid outlet;
wherein the filter is configured to remove at least a portion of a molybdenum residue, a tungsten residue, or any combination thereof in the filtered vapor;
wherein the vapor comprises at least one of MoO₂Cl₂, MoOCl₄, MoCl₅, WCl₆, WCl₅, WOCl₄, WO₂Cl₂, or any combination thereof; and
installing the system to a vapor delivery system, wherein the system is installed into a delivery manifold of the vapor delivery system.

20. The method of claim 19, comprising installing a ballast member between the conduit and the filter.
